(19) United States
(12) Patent Application Publication
(10) Pub. No.: US 2009/0032162 A1
(43) Pub. Date: Feb. 5, 2009

(54) BELT ASSEMBLIES AND PNEUMATIC TIRES INCLUDING THE SAME

(76) Inventors: Xiao-Dong Pan, Akron, OH (US); Walter Tomaszewski, Canton, OH (US); Edward D. Kelly, Tallmadge, OH (US)

Correspondence Address: Jon D. Wood, Chief I.P. Counsel;Bridgestone Americas Holding, Inc., 1200 Firestone Parkway, Akron, OH, 44317, US

(21) Appl. No.: 12/184,794

(22) Filed: Aug. 1, 2008

Related U.S. Application Data
(60) Provisional application No. 60/962,988, filed on Aug. 2, 2007.

(51) Int. Cl. B60C 9/18; C08K 5/13

(52) U.S. Cl. 152/537; 524/323

(57) ABSTRACT

A pneumatic tire comprising a carcass, a tread assembly, a sidewall assembly, and a belt assembly, where the belt assembly includes at least one reinforcing element disposed within a matrix, where the matrix is a vulcanizate prepared from a skim stock prepared by combining an elastomer, a filler, a curative, a methylene donor, and a phenol derivative.

This application claims the benefit of U.S. Provisional Patent Application Ser. No. 60/962,988, filed Aug. 2, 2007, which is incorporated herein by reference.

### FIELD OF THE INVENTION

One or more embodiments of the present invention relate to rubber compositions and vulcanizates useful as belt skims, belt assemblies including the same, and pneumatic tires prepared therewith.

### BACKGROUND OF THE INVENTION

Belted tires include a belt or belt-like structure incorporated under the tread in the crown region of the tire carcass so as to introduce a degree of restraint into the deformability of the tread. The belt may be made of one or more plies of generally inextensible reinforcing cords that may be parallel to each other and confined between ply-wide skim coats or layers of rubber.

There is a desire to form maximum adhesion between the reinforcing cords and the skim rubber. The cords are often made of metal and therefore achieving adhesion between the cords and the skim rubber has offered many technological challenges that continue today.

### SUMMARY OF THE INVENTION

In one or more embodiments, the present invention provides a pneumatic tire comprising a carcass, a tread assembly, a sidewall assembly, and a belt assembly, where the belt assembly includes at least one reinforcing element disposed within a matrix, where the matrix is a vulcanizate prepared from a skim stock prepared by combining an elastomer, a filler, a curative, a methylene donor, and a phenol derivative.

In one or more embodiments, the present invention provides a belt assembly comprising at least one reinforcing element contained within a matrix, where the matrix is a vulcanizate prepared from a skim stock prepared by prepared by combining an elastomer, a filler, a curative, a methylene donor, and a phenol derivative.

In one or more embodiments, the present invention provides a vulcanizable composition of matter useful as a belt skim, the composition prepared by combining a rubber, a filler, a curative, a methylene donor, and a phenol derivative.

### BRIEF DESCRIPTION OF THE DRAWINGS

FIG. 1 is a cross-sectional view of half of a pneumatic tire according to one or more embodiments of this invention.

FIG. 2 is a perspective view of a pneumatic tire showing various tire components in a partially fragmented view according to one or more embodiments of this invention.

### DETAILED DESCRIPTION OF ILLUSTRATIVE EMBODIMENTS

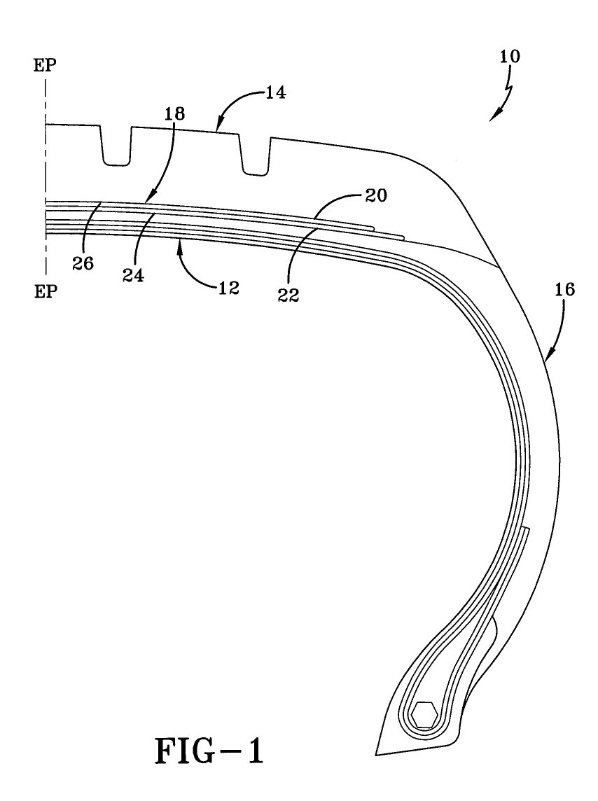

An example of a tire according to the present invention is shown in FIG. 1. Tire 10 includes a tire carcass 12, a tread assembly 14, a sidewall assembly 16, and a belt assembly 18 disposed between carcass 12 and tread 14. Only half of tire 10 is depicted in FIG. 1 with the other half being a substantial mirror image of the half that is depicted.

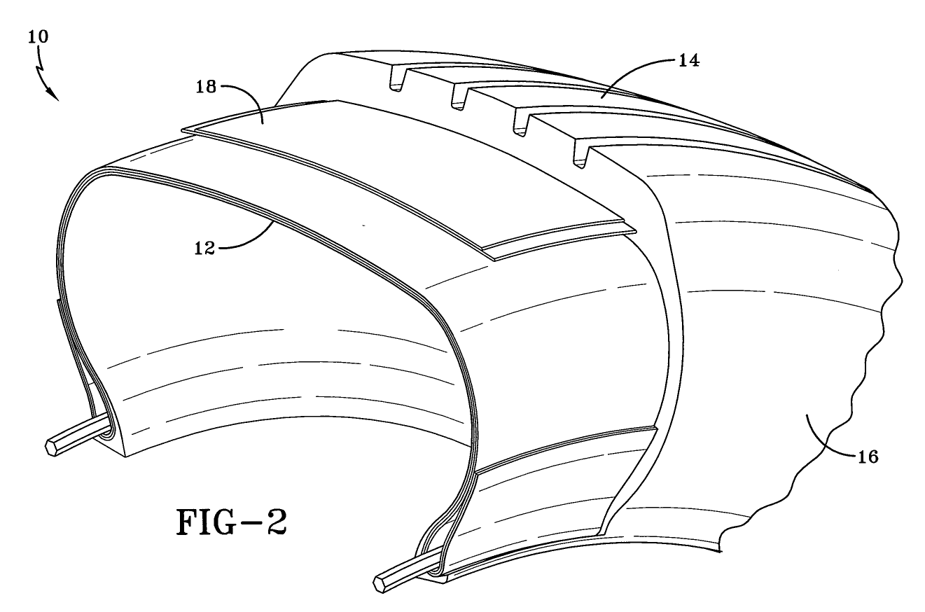

Belt assembly 18 may include one or more reinforced belt plies such as belt ply 20 and optional belt ply 22. In certain embodiments, belt assembly 18 may include additional belt plies, which are not shown. The belt plies, such as belt ply 22, may include reinforcing cords 24 disposed within a matrix 26. Cords 24 may be positioned parallel to one another within each ply and extend circumferentially around carcass 12. As shown in FIG. 2, belt assembly 18 can be positioned below tread assembly 14 circumferentially around tire carcass 12. In one or more embodiments, belt ply 20 may be confined between ply-wide scim coats or layers of rubber. Belt assemblies are shown in U.S. Pat. No. 5,382,621, which is incorporated herein by reference.

In one or more embodiments, cords 24 may include steel wires, including those coated with brass or zinc. In other embodiments, the steel wires may be bronze coated. Steel wires or belts employed in practicing the present invention include those conventionally employed in the art including those disclosed in U.S. Pat. Nos. 5,126,501 and 7,201,944, which are incorporated herein by reference. In one or more embodiments, the steel wires are aligned in parallel fashion within a plane or substantially within a single plane of the belt assembly.

In one or more embodiments, matrix 26 includes a vulcanizate deriving from the vulcanization of a rubber composition, which may also be referred to as a skim stock.

In one or more embodiments, the skim stock from which vulcanized rubber matrix 26 derives includes a rubber mixture, which may also be referred to as a vulcanizable composition. In one or more embodiments, the vulcanizable composition is prepared by combining an elastomer (i.e., polymer capable of being vulcanized into a vulcanizate demonstrating elastomeric properties), a filler, a curative, a methylene donor, and a phenol derivative. In these or other embodiments, other ingredients that may be combined to form the skim stock including processing oils, vulcanization modifiers, and other constituents commonly employed in the art of making rubber mixtures or vulcanizable compositions for the preparation of tire components, particularly skim stocks. It has advantageously been discovered that the use of phenol derivatives within skim stocks unexpectedly improves the adhesion of the skim stock to the cords embedded within the skim stock.

In one or more embodiments, the elastomer includes natural rubber. In other embodiments, the elastomer includes a synthetic rubber. In yet other embodiments, the elastomer includes a blend of a natural rubber and a synthetic rubber. Useful synthetic elastomers include synthetic polyisoprene, polybutadiene, polyisobutylene-co-isoprene, neoprene, poly(ethylene-co-propylene), poly(styrene-co-butadiene), poly(styrene-co-isoprene), and poly(styrene-co-isoprene-co-butadiene), poly(isoprene-co-butadiene), poly(ethylene-co-propylene-co-diene), polysulfide rubber, acrylic rubber, urethane rubber, silicone rubber, epichlorohydrin rubber, and mixtures thereof. These elastomers can have a myriad of macromolecular structures including linear, branched, and star shaped polymers.

In one or more embodiments, the curative may include any curative capable of crosslinking or curing the elastomer. In one or more embodiments, these curative include sulfur or peroxide-based curatives. The curatives may include a crosslinking agent in conjunction with a cure activator. The combination of a crosslinking agent and a cure activator may be referred to as a cure system. Curing agents and cure systems are described in Kirk-Othmer, Encyclopedia of Chemical Technology, 365-468, (3^{rd} Ed. 1982), particularly Vulcanization Agents and Auxiliary Materials, 390-402, and A. Y. Coran, Vulcanization in Encyclopedia of Polymer Science and Engineering, (2^{nd} Ed. 1989), which are incorporated herein by reference. Vulcanizing agents may be used alone or in combination. In these or other embodiments, the crosslinking agents may be used in conjunction with cure accelerators and/or cure retarders. In one or more embodiments, the process of crosslinking or vulcanizing results in a three dimensional crosslinked infinite rubber network.

In one or more embodiments, fillers that may be employed include inorganic and organic fillers. The organic fillers may include carbon black and starch. The inorganic fillers may include silica, aluminum hydroxide, magnesium hydroxide, clays (hydrated aluminum silicates), and mixtures thereof.

In one or more embodiments, phenol derivatives, may be defined by the general formula

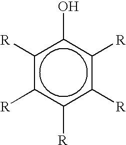

where each R is independently selected from hydrogen, a hydroxyl group, and a mono-valent organic group, with the proviso that at least one R is a mono-valent organic group. In these or other embodiments, at least one R is a hydroxyl group.

In one or more embodiments, the mono-valent organic groups may include hydrocarbyl groups or substituted hydrocarbyl groups such as, but not limited to alkyl, cycloalkyl, substituted cycloalkyl, alkenyl, cycloalkenyl, substituted cycloalkenyl, aryl, allyl, substituted aryl, aralkyl, alkaryl, and alkynyl groups. In particular embodiments, the at least one R is a hydrocarbyl group including at least 3, in other embodiments at least 10, in other embodiments at least 12 and in other embodiments at least 15 carbon atoms. In these or other embodiments, the at least one R is a hydrocarbyl group including less than 30, in other embodiments less than 20, and in other embodiments less than 18 carbon atoms. In particular embodiments, the at least one R is a hydrocarbyl group including at least one double bond (i.e., is unsaturated or is an alkenyl group). Those phenol derivatives containing an unsaturated hydrocarbyl group may be referred to as alkenyl phenols. In other embodiments, the at least one R group includes at least two double bonds. In other embodiments, the at least one R group includes three double bonds. In one or more embodiments, the at least one R group that is a hydrocarbyl group is positioned meta to the —OH group (i.e., hydroxyl group).

In one or more embodiments, the phenol derivatives include cashew nutshell oil and/or a bi-product thereof. In one or more embodiments, cashew nutshell liquid or oil refers to the oil obtained from the spongy layer between the inner and outer shells of cashew nuts. The raw liquid may contain about 90% anacardic acid (C₂₂H₃₂O₃), and a blistering compound containing sulfur. It is believed that upon heat extraction, decarboxylation of the anacardic acid leads to compositions that include cardanol, cardol, derivatives thereof, and polymerization products thereof. In one or more embodiments, the alkenyl phenol added and/or used in the skim stocks of the present invention include cardanol, cardanol derivatives, cardol, cardol derivatives, and/or the condensation or polymerization products of cashew nutshell oil, as well as mixtures thereof.

In one or more embodiments, alkenyl phenols can include one or more of the following compounds including mixtures thereof:

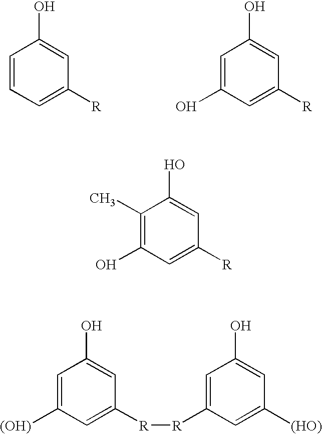

where R is a hydrocarbyl group including about 15 carbon atoms. In particular embodiments, the R group may be selected from the formulae:

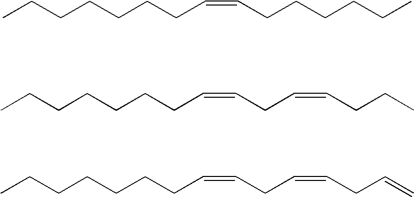

In one or more embodiments, the phenol derivatives may include a hydrocarbyl phenol, a hydrocarbyl resorcinol, ring-substituted derivates thereof, oligomers thereof, and mixtures of two or more thereof. In particular embodiments, a blend of 3-pentadecadienyl phenol, 3-pentadecatrienyl phenol, 3-pentadecenyl phenol, 3-pentadecadienyl resorcinol, 3-pentadecatrienyl resorcinol, 2-methyl-3-pentadecadienyl resorcinol, 2-methyl-3-pentadecatrienyl phenol, 2-methyl-3-pentadecenyl phenol is employed.

In one or more embodiments, useful alkenyl phenols include those materials available under the tradename Cardolite NX-4670 (Cardolite Corporation; Neward, N.J.), which is believed to be a by-product of cashew nutshell liquid processing. Cardolite NX-4670 is believed to be synonymous with Cardolite NX-2005. This particular product is believed to include about 40% cardanol, about 10% cardol, about 1% methyl cardol, and about 40% polymeric cashew nutshell liquid, which is believed to include about 60% dimer and about 20% trimer. This product is believed to have a maximum viscosity of about 12,000 cps at 25° C., a pH of about 10.0 to about 11.7, and a specific gravity of about 1.0.

In one or more embodiments, useful alkenyl phenols include those materials available under the tradename Cardolite™ NC-360, which is a liquid binder for friction material and liquid reactive softener or tackifier for rubber. Cardolite™ NC-360 has a viscosity ranging from 32,000 cps to 42,000 cps at 25° C. This material, which is believed to be a partially polymerized nutshell oil resin, as derived from copolymerization of cardol and anacardol. The polymerization reaction may be conducted in the presence of an acid catalyst. Examples of acid catalysts include oxalic acid, hydrochloric acid, sulfuric acid and p-toluenesulfonic acid. After the catalytic polymerization reaction, the liquid resin is isolated.

Other commercially available alkenyl phenols include Cardolite LX-5345, which is believed to have a maximum viscosity of about 12,000 cps at 25° C., a pH value of about 6.5 to about 7.5, and a specific gravity of about 1.0. Other examples include Cardolite NX-5056, which is believed to have a viscosity of about 12,000 to about 30,000 cps at 25° C., a pH value of 10.0 to about 11.7, and a specific gravity of about 1.0. Other examples include Cardolite NC-361, which is believed to have a viscosity of about 25,000 cps to about 40,000 cps at 25° C., a pH value of about 2.7 to about 3.6, and a specific gravity of about 0.99. Still other examples include Cardolite NC-370, which is believed to have a viscosity of about 25,000 to about 75,000 cps at 50° C., a pH value of about 2.7 to about 3.6, and a specific gravity of about 1.00.

In one or more embodiments, the alkenyl phenols may be characterized by a viscosity of less than 45,000, in other embodiments less than 40,000, in other embodiments less than 30,000, in other embodiments less than 20,000, and in other embodiments less than 15,000 cps at 25° C. In these or other embodiments, the alkyl phenols may be characterized by a viscosity of at least 500, in other embodiments at least 1,000, and in other embodiments at least 2,500 cps at 25° C.

In one or more embodiments, methylene donors include those compounds capable of reacting with the phenol derivatives. Examples of methylene donors that are suitable for use in the present invention include hexamethylenetetramine, hexamethoxymethylmelamine, hexaethoxymethylmelamine, imino-methoxymethylmelamine, imino-isobutoxymethylmelamine, lauryloxymethylpyridinium chloride, ethoxymethylpyridinium chloride trioxan and hexamethoxymethylmelamine. In one or more embodiments, the methylene donors may be N-substituted oxymethylmelamines. An example may be defined by the general formula:

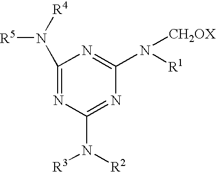

wherein X is hydrogen or an alkyl having from 1 to 8 carbon atoms, R¹, R², R³, R⁴ and R⁵ are individually selected from the group consisting of hydrogen, an alkyl having from 1 to 8 carbon atoms, the group—CH₂OX or their condensation products. Specific methylene donors include hexakis-(methoxymethyl)melamine, N,N′,N″-trimethyl/N,N′,N″-trimethylolomelamine, hexamethylolmelamine, N,N′,N″-dimethylolmelamine, N-methylolmelamine, N,N′-dimethylolmelamine, N,N′,N″-tris(methoxymethyl)melamine and N, N′,N″-tributyl-N,N′,N″-trimethylol-melamine. The N-methylol derivatives of melamine are prepared by known methods. In one or more embodiments, the methylene donor may be accompanied by an inert carrier, such as silica. Useful methylene donors are disclosed in U.S. Pat. Nos. 6,467,520, 5,030,692, 5,266,620, 5,126,501, 7,201,944, and 7,132,481, which are incorporated herein by reference.

Other ingredients that may be employed include metal accelerators, oils, waxes, scorch inhibiting agents, processing aids, zinc oxide, tackifying resins, reinforcing resins, fatty acids such as stearic acid, peptizers, and one or more additional rubbers.

In one or more embodiments, the skim stock may include a metal adhesion promoter. These metal adhesion promoters may include those conventionally employed in the art of making tires. Examples include cobalt salts of organic acids, hydroxybenzoic acid, resorcinol, complexes of organo cobalt and boron, and mixtures thereof. Useful adhesion promoters are disclosed in U.S. Publication Nos 2007/0010606, 2003/0188818, and 2002/0055011 and U.S. Pat. Nos. 4,258,770, 4,511,628, 5,126,501, and 4,594,381, which are incorporated herein by reference. In one or more embodiments, the skim stocks include at least 1.0 parts by weight (pbw), in other embodiments at least 1.5 pbw, and in other embodiments at least 2.0 pbw, per 100 parts by weight rubber, of the phenol derivatives (e.g., alkenyl phenol); in these or other embodiments, the skim stocks include less than 20 pbw, in other embodiments less than 10 pbw, and in other embodiments less than 5 pbw, per 100 parts by weight rubber, of the phenol derivatives.

In one or more embodiments, the skim stocks include at least 0.2 pbw, in other embodiments at least 1.0 pbw, and in other embodiments at least 2.0 pbw, per 100 parts by weight rubber, of the methylene donor; in these or other embodiments, the skim stocks include less than 20 pbw, in other embodiments less than 10 pbw, and in other embodiments less than 5 pbw, per 100 parts by weight rubber, of the methylene donor.

In one or more embodiments, the skim stocks of the present invention include at least 20 pbw, in other embodiments at least 30 pbw, and in other embodiments at least 40 pbw, per 100 parts by weight rubber, of a filler; in these or other embodiments, the skim stocks include less than 100 pbw, in other embodiments less than 80 pbw, and in other embodiments less than 70 pbw, per 100 parts by weight rubber, of a filler. Where the skim stock includes a blend of silica and another filler (e.g., carbon black), the skim stock may include up to 10 pbw, in other embodiments up to 7 pbw, and in other embodiments up to 5 pbw silica per 100 parts by weight rubber, with the balance of the filler including the other filler material (e.g., carbon black).

In one or more embodiments, the skim stocks of the present invention include at least 0.1 pbw, in other embodiments at least 0.5 pbw, and in other embodiments at least 0.7 pbw, per 100 parts by weight rubber, of a metal adhesion promoter; in these or other embodiments, the skim stocks include less than 2.0 pbw, in other embodiments less than 1.5 pbw, and in other embodiments less than 1.0 pbw, per 100 parts by weight rubber, of a metal adhesion promoter.

In one or more embodiments, the skim stocks of the present invention include 0 pbw, in other embodiments at least 1.0 pbw, and in other embodiments at least 2.0 pbw, per 100 parts by weight rubber, of a processing oil; in these or other embodiments, the skim stocks include less than 12 pbw, in other embodiments less than 10 pbw, and in other embodiments less than 5 part by weight of a processing oil, per 100 parts by weight rubber.

In one or more embodiments, the rubber content of the skim stock includes at least 50, in other embodiments at least 70, and in other embodiments at least 90 percent by weight natural rubber. In one or more embodiments, 100% of the rubber content of the skim stock includes natural rubber.

In one or more embodiments, the skim stocks of the present invention do not contain, or contain only limited amounts of, a novolac resin or other acid-catalyzed thermosetting phenol or resorcinol resin. In these or other embodiments, the skim stocks of the present invention do not contain, or contain only limited amounts of, a resole resin or other alkaline-catalyzed thermosetting phenol or resorcinol resin. In one or more embodiments, the skim stocks are substantially devoid of novolac resins, which refers to an amount of novolac resin or less that does not have a material impact on the skim stock. In these or other embodiments, the skim stocks are substantially devoid of resole resins, which refers to an amount of resole resin or less that does not have a material impact on the skim stock.

In one or more embodiments, the vulcanizable composition is prepared by combining an elastomer (i.e., polymer capable of being vulcanized into a vulcanizate demonstrating elastomeric properties), a filler, a curative, a methylene donor, and phenol derivative. In these or other embodiments, other ingredients that may be combined to form the skim stock include a processing oil, vulcanization modifiers and other constituents commonly employed in the art of making rubber mixtures or vulcanizable compositions for the preparation of tire components, particularly skim stocks.

In one or more embodiments, an initial masterbatch is prepared by mixing the rubbery polymer and filler. This initial masterbatch may be mixed at a starting temperature from about 25° C. to about 125° C. with a discharge temperature of about 135° C. to about 180° C. Scorch inhibiting agents may also be added to this initial masterbatch. Once this initial masterbatch is processed, the vulcanizing agents can be introduced and mixing continued at relatively low temperatures so as to inhibit or discourage vulcanization. The low temperature mixing of the vulcanizing agents is typically referred to as the final mix stage. Optionally, additional mixing stages, sometimes called remill, can be employed between the initial masterbatch and the final mix stage. The phenol derivative may be added during materbatch or remill mixing wile the methylene donor may be added during the final mixing stage.

In one or more embodiments, the phenol derivative (e.g., cashew nutshell liquid) and the methylene donor are added exclusively and/or directly to the elastomer. In other words, in one or more embodiments, the phenol derivative and the methylene donor are not pre-introduced or pre-combined with each other prior to introduction to the elastomer. Inasmuch as a reaction is believed to occur between the phenol derivative and the methylene donor, this reaction occurs in situ (i.e., within the elastomer formulation).

The belt assembly, as well as the other components of the tires of this invention, may be manufactured by employing conventional procedures.

Rubber compounding techniques and the additives employed therein are generally known as disclosed in Stephens, The Compounding and Vulcanization of Rubber, in Rubber Technology (2^{nd} Ed. 1973). The mixing conditions and procedures applicable to silica-filled tire formulations are also well known as described in U.S. Pat. Nos. 5,227,425, 5,719,207, 5,717,022, and European Patent No. 890,606, all of which are incorporated herein by reference.

The vulcanizable compositions of this invention can be fabricated into components and tires by employing conventional rubber shaping, molding, and curing techniques. In one or more embodiments, a green belt assembly is formed by extruding the vulcanizable composition to form a green matrix around a plurality of wires. These techniques are known in the art as described in U.S. Pat. Nos. 7,201,944 and 5,126,501, which are incorporated herein by reference.

In one or more embodiments, vulcanization can be effected by heating the vulcanizable composition within a mold. In one or more embodiments, the composition can be heated at a temperature from about 140° C. to about 180° C. The cured or crosslinked rubber compositions (i.e., vulcanizates) generally include three-dimensional polymeric networks that are thermoset. Other ingredients, such as processing aids and fillers, as well as the fibers described in this invention, are generally dispersed throughout the vulcanized network. Pneumatic tires can be made as discussed in U.S. Pat. Nos. 5,866,171, 5,875,527, 5,931,211, and 5,971,046, which are incorporated herein by reference.

In order to demonstrate the practice of the present invention, the following examples have been prepared and tested. The examples should not, however, be viewed as limiting the scope of the invention. The claims will serve to define the invention.

### EXAMPLES

Rubber compositions were prepared, cured, and tested for various properties. The ingredients employed to prepare each of the rubber compositions is provided in Table I. Compound mixing was performed within a brabender mixer, equipped with Cam blades. A 4-stage mixing procedure was employed for each mixture, which included the formation of a masterbatch, two remils, and a final mix.

TABLE I

| Samples | Control 1 | Control 1 | Sample 1 | Sample 2 |
|---|---|---|---|---|
| Natural Rubber | 100 | 100 | 100 | 100 |
| Carbon Black | 55 | 55 | 55 | 55 |
| Alkylphenolic Resin | 1.9 | 1.9 | 1.9 | 1.9 |
| Zinc Oxide | 6 | 6 | 6 | 6 |
| Antioxidant I | 2.5 | 2.5 | 2.5 | 2.5 |
| Antioxidant II | 1 | 1 | 1 | 1 |
| Resorcinol | 0 | 2.5 | 0 | 0 |
| Alkenyl Phenol I | 0 | 0 | 2.5 | 0 |
| Alkenyl Phenol II | 0 | 0 | 0 | 2.5 |
| Colbalt Salt (Cobalt | 0.85 | 0.85 | 0.85 | 0.85 |
| Boro-Neodecanoate) | | | | |
| HMMM | 3.5 | 3.5 | 3.5 | 3.5 |
| Sulfur/oil preblend | 6 | 6 | 6 | 6 |
| Accelerator | 0.8 | 0.8 | 0.8 | 0.8 |

The carbon black was N326 Carbon Black, Antioxidant I was N-(1,3-dimethylbutyl)-N′-phenyl-p-phenylenediamine, Antioxidant II was polymerized 2,2,4-trimethyl-1,2-dihydroquinoline, the accelerator was N,N-dicyclohexyl-2-benzothiazyl sulfenamide, the sulfur/oil preblend was believed to be 80% active sulfur, the cobalt salt was cobalt boro-neodecanoate, and the HMMM resin was a 72% active hexamethoxymethyl melamine carried on silica. Alkenyl Phenol I was obtained under the tradename Cardolite NX-4670, which is believed to be synonymous with Cardolite NX-2005. Alkenyl Phenol II was obtained under the tradename Cardolite NC-360.

Uncured rubber mixtures were prepared into uncured test samples or specimens pursuant to standardized test methods. The ring tensile data (i.e. modulus at 300%, tensile at break, and elongation at break) were determined according to ASTM-D 412. Samples were also aged for one day at 100° C. for aged ring tensile testing. Shore A hardness was determined at room temperature. The rubber-steel cord adhesion test was performed at room temperature with a Model 4501 Instron universal tester at a crosshead speed of 50 mm/min. The pull-out force was recorded. For this adhesion test, adhesion pads were prepared from rubber extrudates approximately 21.6 cm long, approximately 3.8 cm wide, and approximately 0.46 cm thick. The adhesion pad was constructed by placing seven cords (brass or zinc coated wire) that were approximately 22 cm in length at equally spaced intervals over a width of approximately 9 mm at the bottom of the mold cavity. Over the cords was placed the rubber extrudate, and a fabric backing was placed on top of the extrudate. The sample was encased in the mold and cured under high pressure for 40 minutes at 149° C. and then allowed to equilibrate for 24 hours before testing. With the assistance of a blade, approximately 12 cm of the second, forth, and sixth cords were uncovered and affixed to the top grip of the Instron machine, while the other end of the pad was affixed to the bottom grip of the Instron machine. The average total force to pull out the cords, divided by three, is reported in Table II as the pull-out force per cord. Samples were also heat aged for two days at 120° C. and tested for rubber-steel cord adhesion using the same method. Also, samples were humidity aged for 14 days at 50° C. and 95% relative humidity and likewise tested for rubber-steel cord adhesion using the same method. The results of the various tests that were performed are provided in Table II.

TABLE II

| | | | | |
|---|---|---|---|---|
| Sample | Control 1 | Control 1 | Sample 1 | Sample 1 |

Cure test at 149° C. for 45 min.

| | | | | |
|---|---|---|---|---|
| Maximum torque dN · m | 26.7 | 35.3 | 26.7 | 27.4 |
| t′90 | 22.7 | 15 | 25.0 | 24.7 |

Ring Tensile

| | | | | |
|---|---|---|---|---|
| Mod 300% (Mpa) | 15.97 | 15.08 | 15.16 | 14.71 |
| Tensile at break (Mpa) | 19.52 | 16.88 | 18.63 | 16.75 |
| Elongation at break (%) | 360.9 | 334.0 | 360.1 | 338.8 |

Aged Ring Tensile

| | | | | |
|---|---|---|---|---|
| Tensile at break (Mpa) | 12.13 | 10.98 | 13.2 | 11.37 |
| Elongation at break (%) | 143.8 | 154.9 | 165.3 | 147.3 |
| Shore A Hardness | 62.7 | 63.5 | 64.1 | 65.3 |

Rubber-Steel Cord Adhesion Test Pull-Out Force (kgf/cord)
Unaged samples

| | | | | |
|---|---|---|---|---|
| With brass-coated wires | 6.72 | 6.75 | 7.82 | 9.28 |
| With zinc-coated wires | 4.25 | 3.47 | 6.03 | 8.00 |

Heat-aged samples

| | | | | |
|---|---|---|---|---|
| With brass-coated wires | 2.78 | 2.50 | 3.68 | 3.39 |
| With zinc-coated wires | 2.32 | 2.74 | 3.28 | 3.23 |

Humidity-aged Samples

| | | | | |
|---|---|---|---|---|
| With brass-coated wires | 5.46 | 5.11 | 9.73 | 8.92 |
| With zinc-coated wires | 3.31 | 2.51 | 5.15 | 5.48 |

Various modifications and alterations that do not depart from the scope and spirit of this invention will become apparent to those skilled in the art. This invention is not to be duly limited to the illustrative embodiments set forth herein.

What is claimed is:

1. A pneumatic tire comprising:
a carcass;
a tread assembly;
a sidewall assembly; and
a belt assembly, where the belt assembly includes at least one reinforcing element disposed within a matrix, where the matrix is a vulcanizate prepared from a skim stock prepared by combining an elastomer, a filler, a curative, a methylene donor, and a phenol derivative.

2. The tire of claim 1, where the elastomer includes natural rubber.

3. The tire of claim 1, where the skim stock is prepared by combining an elastomer, a filler, a curative, a methylene donor, a phenol derivative, and a metal adhesion promoter.

4. The tire of claim 3, where the metal adhesion promoter is a cobalt salt.

5. The tire of claim 1, where the phenol derivative is defined by the formula: 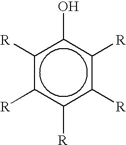
where each R is independently selected from the hydrogen, a hydroxyl group, and a monovalent organic group, with the proviso that at least one R is a monovalent organic group.

6. The tire of claim 5, where at least one R is an alkenyl group including at least three and less than 30 carbon atoms.

7. The tire of claim 6, where the R group that is meta to the hydroxyl group is an alkenyl group including at least 10 and less than 20 carbon atoms.

8. The tire of claim 1, where the phenol derivative is cashew nutshell oil or a by-product thereof.

9. The tire of claim 8, where the cashew nutshell oil or by-product thereof includes cardanol, cardanol derivatives, cardol, cardol derivatives, the condensation or polymerization products of cashew nutshell oil, or mixtures of two or more thereof.

10. The tire of claim 4, where the phenol derivative includes one or more compounds defined by the formulae: 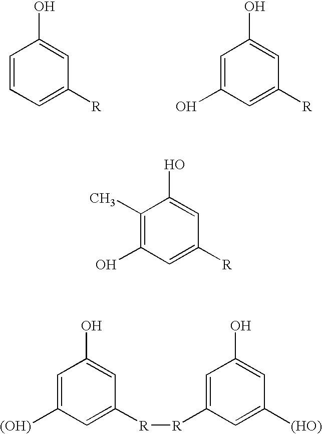
where R is a hydrocarbyl group including about 15 carbon atoms.

11. The tire of claim 10, where R may be selected from the formulae:

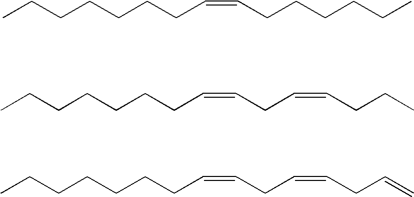

12. The tire of claim 1, where the phenol derivative has a viscosity of less than 45,000 cps at 25° C.

13. The tire of claim 1, where the phenol derivative has a viscosity of less than 20,000 cps at 25° C.

14. The tire of claim 1, where the phenol derivative includes a compound selected from the group consisting of 3-pentadecadienyl phenol, 3-pentadecatrienyl phenol, 3-pentadecenyl phenol, 3-pentadecadienyl resorcinol, 3-pentadecatrienyl resorcinol, 2-methyl-3-pentadecadienyl resorcinol, 2-methyl-3-pentadecatrienyl phenol, and 2-methyl-3-pentadecenyl phenol.

15. The tire of claim 1, where the reinforcing element is a steel cord.

16. The tire of claim 15, where the steel cord is coated with brass or zinc.

17. The tire of claim 15, where the belt assembly includes a plurality of steel cords.

18. The tire of claim 17, where the plurality of steel cords are aligned in a parallel fashion substantially within a single plane of the belt assembly.

19. A belt assembly comprising:
at least one reinforcing element contained within a matrix, where the matrix is a vulcanizate prepared from a skim stock prepared by prepared by combining an elastomer, a filler, a curative, a methylene donor, and a phenol derivative.

20. A vulcanizable composition of matter useful as a belt skim, the composition prepared by combining:
a rubber;
a filler;
a curative;
a methylene donor; and
a phenol derivative.
